(19) United States
(12) Patent Application Publication
(10) Pub. No.: US 2005/0125241 A1
(43) Pub. Date: Jun. 9, 2005

(54) Franchised do it yourself automotive repair shops

(76) Inventors: Matthew Edward Jarmon, Esmont, VA (US); Brian Scott Jarmon, Waldorf, MD (US); Melva Louise Jarmon, Waldorf, MD (US)

Correspondence Address: Mrs. Melva L. Jarmon, 2017 Bainbridge Court, Waldorf, MD, 20602, US

(21) Appl. No.: 10/727,085

(22) Filed: Dec. 3, 2003

(51) Int. Cl. G06F 17/60

(52) U.S. Cl. 705/1

(57) ABSTRACT

Experienced mechanics available to assist the customers, both genders, in their safe and private bay area with questions and/or concerns associated with repair(s), state-of-the art equipment made available too, repair services provided, on a limited basis, for the consumers. Lounge and eatery accessible to consumers as well as a fun and comfortable work environment. Plastic gloves, jumpsuits as a means of maintaining the cleanliness of personal clothing furnished as well as rest rooms with enough space for the cleaning of hands and/or face with solution(s) as well as any item required based on state and/or federal laws will be furnished. Bay areas will be warm during the cool too, cold climatic periods and conversely, bay areas will be cool during warm too, hot climatic periods. When finished repairing automobile, motorized bike, truck, sport utility vehicle, passenger van or other mode of transportation, customer do not have to be concerned regarding the cleaning of bay area as well as clothing; just, leave jumpsuit, removed parts, tires and/or oil in bay area.

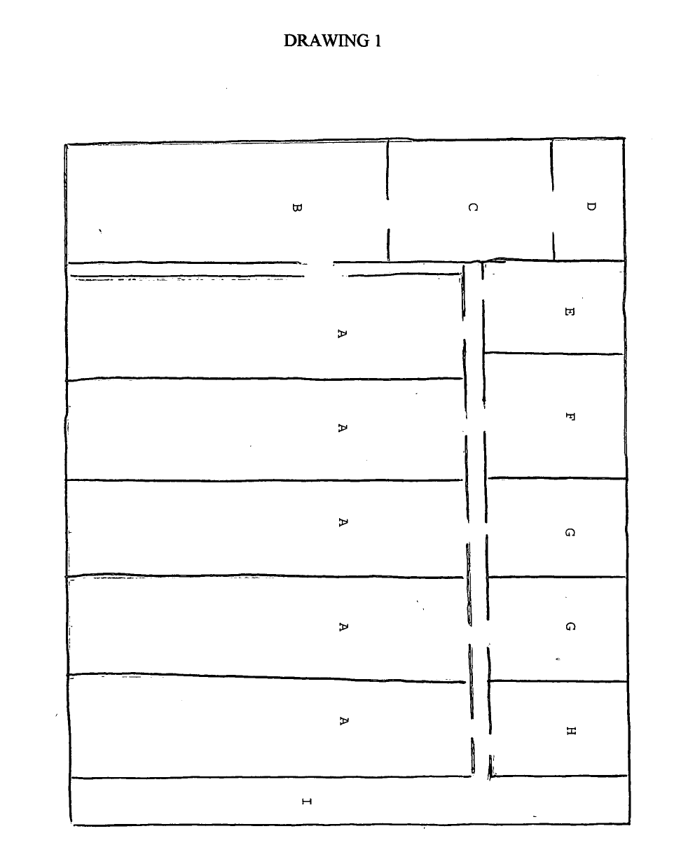

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The invention relates to the ability of consumers especially, of the female gender, to maximize earnings via providing a work site as a means of repairing automobiles, sport utility vehicles, trucks as well as other motorized modes of transportation. In the automotive repair industry, the consumers must absorb the high cost associated with the repair of their automotive transportation in which such costs consist of parts and labor additionally in many instances, costs consist of towing and/or storage as well as. The cost associated with parts, labor, towing as well as storage of automotive type machinery increase during inflationary economic economic conditions in which this cost remains the on going cost versus decreasing when the state of the economy improves. Many consumers who desire to make repair(s), do not have a safe work site and/or appropriate equipment and tools in which to perform task(s) in an expeditious manner. Lack of knowing automotive repair savvy individuals too, knowing such individuals; however, no time can be expended to assist as well as lack of self confidence are issues confronting many individuals who possess the desire to do own repair(s). Additionally far too many, male driven societies fail to recognize that there are many females who desire to perform automotive repairs; however do not, due to lack of strong support from the male driven automotive industry, males and/or female peers as well as for the same reasons as cited above.

### BRIEF SUMMARY OF THE INVENTION

Objectives of invention entitled, “Franchised Do It Yourself Automotive Repair Shops” are as follows:—Consumers will perform repair(s) in a fun and relaxed environment—Assistance if required, provided by experts in the field—Will be designed in a manner to provide a safe work site for individuals who desire to repair automobiles, sport utility vehicles, trucks, passenger vans too, other modes of transportation—Shops would provide appropriate equipment and tools—Total cost associated with the repair(s) will result in substantial savings to the customer; lower cost incurred by consumer due to, performing task(s) themselves versus incurring high costs due to services rendered by professional mechanics in the automotive repair industries—To encourage more of the female gender to perform tasks associated with automotive repairs outside the scope of changing tires too, merely being able to change the oil in the engine as a means of maximizing monies vis a vis the male gender and/or diminutive number of females with the know how.

### BRIEF DESCRIPTION OF THE VIEW OF THE DRAWING

Drawing 1 is representative of the proposed floor layout for the building for the invention entitled, “Franchised Do It Yourself Automotive Repair Shops.” One floor level building is proposed. Space allocation, as depicted in drawing, section “A” depicts, bay areas with non-mobile equipment, work stations as well as lockers, section “B” depicts the location of administrative offices, section “C” depicts library for manuals, section “D” depicts storage area for tools and storage area for clean jumpsuits, section “E” depicts the location of snack bar, section “F” depicts location of customer lounge, section “G” depicts location of storage area for moveable equipment, section “H” depicts location of male and female large rest rooms with numerous sinks, section “H” depicts location of washer and dryer as well as storage area for cleaning supplies, and section “I” depicts storage area for moveable equipment.

### DETAILED DESCRIPTION OF THE INVENTION

Invention entitled, “Franchised Do It Yourself Automotive Repair Shops” will be housed in one floor level buildings, drawing 1 enclosed as part of specification, floor layout cited in section entitled, Brief Description Of The View Of The Drawing. Safely structured bay areas with heat and air conditioning for seasonal comfort. Cutting edge equipment and tools available to make repairs, i.e. engine diagnostic machines, various automotive lifts, manual too, hydraulic too, towing service to facilitate performing repairs in a timely manner. Certified mechanics on duty to assist customers (guidance provided and/or limited hands on assistance). Technical repair manuals available for customer's utilization. Cleaning after utilization of bay area provided. Jumpsuits, plastic gloves, goggles as well as cleaning solution for hands and face furnished too, other items mandated by state and/or federal laws. Lounge area provided with limited food and drinks for those moments in which a break is in order and for just communicating with mechanics on duty too, other customers. Seminars offered based on customers demand for such as well as discounts on many parts and discounts for towing services. Temporary storage allowed at a lower cost then, commercial automotive industries. Target market for shops, both genders; however, effort directed towards encouraging more females to learn technical aspects associated with the repairing of automobiles, sport utility vehicles, motorized bikes, trucks, passenger vans and other modes of transportation. Additionally, a female friendly environment will be created to ascertaining that the female gender acquires necessary knowledge as a means of meeting repair objective(s).

The invention entitled, “Franchised Do It Yourself Automotive Repair Shops” would eliminate labor cost associated with the repairing of automobiles, sports utility vehicles, trucks, motorized bikes too, other modes of transportation. Costs associated with the purchasing of parts, storage as well as for towing, would be discounted further, reducing cost for the individuals, both genders, utilizing franchised do it yourself automotive shops.

1. What we claim as our invention are “Franchised Do It Yourself Automotive Repair Shops” for the novice too, seasoned cost conscience, male and female, consumer as a means of furnishing a fun, safe as well as a comfortable environment, in which includes fully equipped private bay areas, i.e. automotive equipment, and tools, for repairing automobiles, motorized bikes, trucks, sports utility vehicles, passenger vans and other modes of transportation as well as assistance furnished too, actual repairing of such for customers.

2. The cost incurred by the consumer will be far less when utilizing the invention entitled, “Franchised Do It Yourself Automotive Repair Shops,” of claim 1, then, the cost the consumer must absorb when taking their automotive transportation to commercial repair shops in regional locations.

3. To determine cost for utilizing, the invention entitled, “Franchised Do It Yourself Automotive Repair Shops,” of claim 1 and 2, will be derived by determining the commercialized average costs for repairs rendered based on regional demographics.

4. Utilizing the invention entitled, “Franchised Do It Yourself Automotive Repairs Shops,” will reduce the costs, of claim 1, associated with purchasing parts, towing as well as storage since, contracts will be negotiated with local businesses as a means of acquiring discounts for shop customers.

5. The invention entitled, “Franchised Do It Yourself Automotive Repair Shops,” will target both genders, of claim 1; however, a concerted effort will be directed towards targeting the female gender as a means of taking advantage of cost savings in the automotive repair arena via taking the initiative to make advanced technical repairs, i.e. replacing an engine or transmission.

6. The invention entitled, “Franchised Do It Yourself Automotive Repair Shops,” will provide the customers with state-of-the-art equipment and tools, of claim 1, necessary to complete repair(s) in a timely and safe manner.

7. The invention entitled, “Franchised Do It Yourself Automotive Repair Shops,” will be designed to provide the customer with a fun and comfortable environment, of claim 1, via offering seminars, having an on-site eatery and lounge as well as temperature control in bay area based on season, i.e. winter, summer.

8. The invention entitled, “Franchised Do It Yourself Automotive Repair Shops,” will have on board at all times, well trained automotive staff who will provide assistance, and/or will do repairs on a limited basis, of claim 1, for customers.

9. The invention entitled, “Franchised Do It Yourself Automotive Repair Shops,” will furnish necessary jumpsuits, plastic gloves, face and/or head gear, body cleaning solution as well as furnish other items based on state and/or federal statutory law requirement(s).

10. The invention entitled, “Franchised Do It Yourself Automotive Repair Shops,” will staff personnel whose area of responsibility would entail cleaning bay areas as well as dispose of parts, oil, tires as well as other items requiring disposing based on repairs in accordance with state and/or federal laws; therefore, when customers have made necessary repairs, their work is completed.
